(19) United States
(12) Patent Application Publication
(10) Pub. No.: US 2016/0239033 A1
(43) Pub. Date: Aug. 18, 2016

(54) Power Switch Control System with Area-Based Switch Grouping

(71) Applicant: LUXUL TECHNOLOGY INCORPORATION, New Taipei City (TW)

(72) Inventors: Cheng-Hung Pan, New Taipei City (TW); Eric Wen-Chien Chen, New Taipei City (TW); Perng-Fei Yuh, New Taipei City (TW)

(21) Appl. No.: 14/715,678

(22) Filed: May 19, 2015

(30) Foreign Application Priority Data
Feb. 17, 2015 (TW) 104105570

(51) Int. Cl. G05F 1/66; H04W 56/00; G05B 15/02; H04L 29/08

(52) U.S. Cl. CPC G05F 1/66; H04L 67/125; H04W 56/001; G05B 15/02

(57) ABSTRACT

A power switch control system with area-based switch grouping utilizes original compartments in a building as groups to be controlled, and includes multiple intelligent switches respectively installed in multiple switch wiring boxes originally and selectively located in the compartments. Each intelligent switch is electrically connected to multiple pieces of power-consuming equipment through a corresponding switch wiring box, and receives switch control commands transmitted from an electronic device to turn on or off the multiple pieces of power-consuming equipment connected to the switch wiring box, so as to group and remotely control power-consuming equipment in the compartments. As no rewiring is needed, the power switch control system can effectively reduce the cost for operation.

### BACKGROUND OF THE INVENTION

1. Field of the Invention

The present invention relates to a power switch control system and, more particularly, to a power switch control system with area-based switch grouping.

2. Description of the Related Art

All power-consuming equipment needs to be managed and controlled in terms of power consumption. Regular home electrical appliances can be controlled in a simple way, namely, a one-to-one control pattern. When the power equipment to be controlled spreads over a large area, such as many floors in a building, the management and control over the power equipment becomes much more complicated. Given a light control system in a building as an example, the use of a digital addressable lighting interface (DALI) system is pretty common. With reference to FIG. 12, a controller 70 is connected to each lamp 72 inside a building through two control lines 71. Each lamp 72 owns a fixed address. The controller 70 turns on or off each lamp 72 with a 6-bit lamp control signal. Each lamp 72 can determine if a received signal is the lamp control signal coming from the controller 70 and decide whether to accept the instruction in the lamp control signal.

The technique of the DALI system is advantageous in controllability and high anti-interference capability and is disadvantageous in the following aspects.

1. Costly wiring of the control lines: The controller 70 needs to transmit the lamp control signal through the two control lines 71. Although a voltage range of signals transmitted by the control lines is just 0-20V, the insulation requirement of the control lines 71 should be the same as that for a power cable. Therefore, the work and material for wiring the control lines 71 are liable for cost increase resulting from implementation of the DALI system.

2. Limited number of controlled lamps: Limited by the 6-bit lamp control signal, a controller 70 can at most control 64 lamps.

3. Complicated and laborious work for installation and modification: In view of 72 lamps as a unit for the DALI system, to simultaneously control all the 72 lamps in a same area, the addresses of all the 72 lamps in the same area must be assigned to a group before the 72 lamps can be simultaneously turned on or off. Thus, installation and modification of the DALI system is complicated and effort-taking.

4. Asynchronous on/off timing: Because the transmission speed of the lamp control signal is rather slow, the DALI system is prone to an effect of switching delay out of Mexican wave. All lamps in a large lighting area end up with different on/off timings.

5. Difficulty in troubleshooting: When the ballast on a lamp in the DALI system is broken and needs to be replaced, the address of the ballast should be known first. However, special equipment is required to determine the address of a ballast.

Due to the prevalence of internet, internet has been introduced into lighting control. With reference to FIG. 13, all lamps 82 inside a building and a router 81 are networked. A computer 80 controls each lamp 82 to turn on or off through the router 81. A so-called Internet of Things (IOT) system is built by the lamps 82, the router 81 and the computer 80.

However, each lamp 82 of the IOT system requires a wireless transmitter and a wireless receiver to connect to a wireless network. Similar to the DALI system, the multiple lamps 82 in a same area need to be located in a same network domain while it is complicated to assign the multiple lamps 82 to an identical group to be controlled. In other words, the cost of building an IOT system is still high and it is also not convenient to manage an LOT system.

### SUMMARY OF THE INVENTION

An objective of the present invention is to provide a power switch control system with area-based switch grouping utilizing areas of a building as groups to be controlled and original wiring in those areas to get rid of the need of rewiring and also achieve easy implementation and cost-saving.

To achieve the foregoing objective, the power switch control system with area-based switch grouping includes multiple intelligent switches and an electronic device.

The multiple intelligent switches are respectively located in at least one compartment of a building, are respectively mounted inside multiple switch wiring boxes originally and selectively located in the at least one compartment, and are respectively connected to multiple power distribution circuits inside the respective switch wiring boxes. Each intelligent switch receives a switch control command according to a wireless communication protocol.

The electronic device generates the switch control command and transmits the switch control command to each intelligent switch according to the wireless communication protocol.

The foregoing power switch control system utilizes compartments originally planned in a building as groups to be controlled, and includes multiple intelligent switches with each intelligent switch mounted inside a corresponding switch wiring box in a corresponding compartment and connected to the power distribution circuit inside the corresponding switch wiring box. As the switch wiring boxes are originally mounted in the planned compartments before the completion of the building, multiple pieces of power-consuming equipment, such as multiple lamps, and switches originally planned in the switch wiring boxes can be used by the power switch control system. Since each intelligent switch of the power switch control system is mounted inside a corresponding switch wiring box and is connected to the power distribution circuit of the corresponding switch wiring box for the multiple lamps, an electronic device can transmit a switch control command to the multiple intelligent switches in the compartments to turn on or off the multiple lamps in the compartments through the multiple intelligent switches. The lamps in different compartments of the building can be defined as different groups to be controlled by the electronic device on a group basis.

Because the power switch control system utilizes the switch wiring boxes originally installed in corresponding compartments of a building and the power distribution circuits in the respective switch wiring boxes for connection to multiple pieces of power-consuming equipment, there is no need of rewiring for controlling the multiple pieces of power-consuming equipment and rewiring cost can be totally avoided. Moreover, original power-consuming equipment can be controlled without requiring mounting an additional transceiving device or reinstalling new power-consuming equipment, thereby significantly lowering the cost in operation.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram illustrating a system architecture of a first embodiment of a power switch control system with area-based switch grouping in accordance with the present invention;

FIG. 2 is a functional block diagram of a first embodiment of an intelligent switch in the power switch control system in FIG. 1;

FIG. 3 is a functional block diagram of a second embodiment of an intelligent switch in the power switch control system in FIG. 1;

FIG. 4 is a functional block diagram of a third embodiment of an intelligent switch in the power switch control system in FIG. 1;

FIG. 5 is a schematic diagram illustrating a system architecture of a second embodiment of a power switch control system with area-based switch grouping in accordance with the present invention;

FIG. 6 is a functional block diagram of an electronic device in FIG. 5;

FIG. 7 is a schematic diagram of a first embodiment of an operation interface of the electronic device in FIG. 5;

FIG. 8 is a schematic diagram of a second embodiment of an operation interface of the electronic device in FIG. 5;

FIG. 9 is a schematic diagram of a third embodiment of an operation interface of the electronic device in FIG. 5;

FIG. 10 is an operational schematic diagram of a power switch control system with area-based switch grouping in accordance with the present invention;

FIG. 11 is another operational schematic diagram of the power switch control system in FIG. 10;

FIG. 12 is a schematic diagram illustrating a system architecture of a conventional DALI system for light control; and

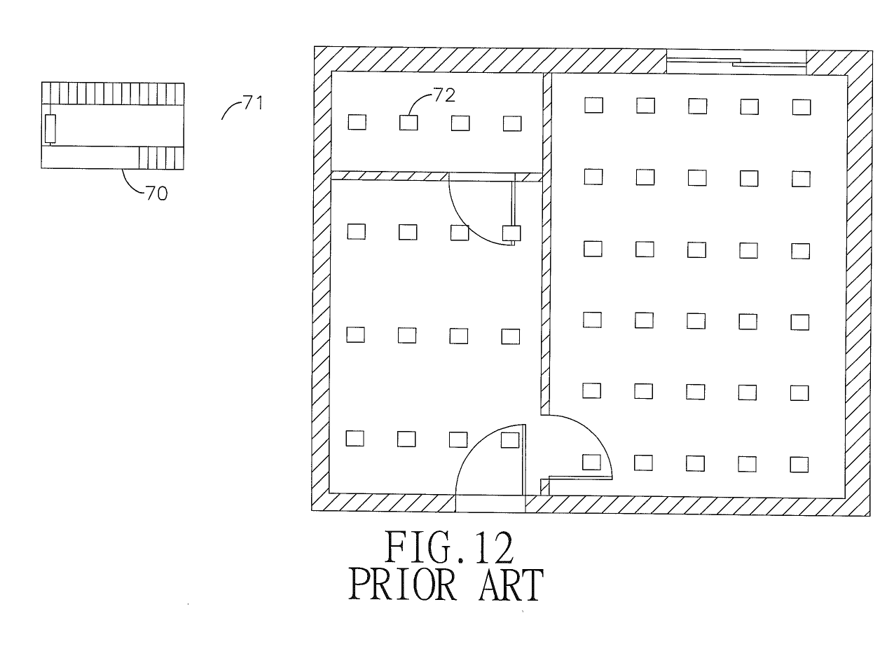

FIG. 13 is a schematic diagram illustrating a system architecture of a conventional IOT system for light control.

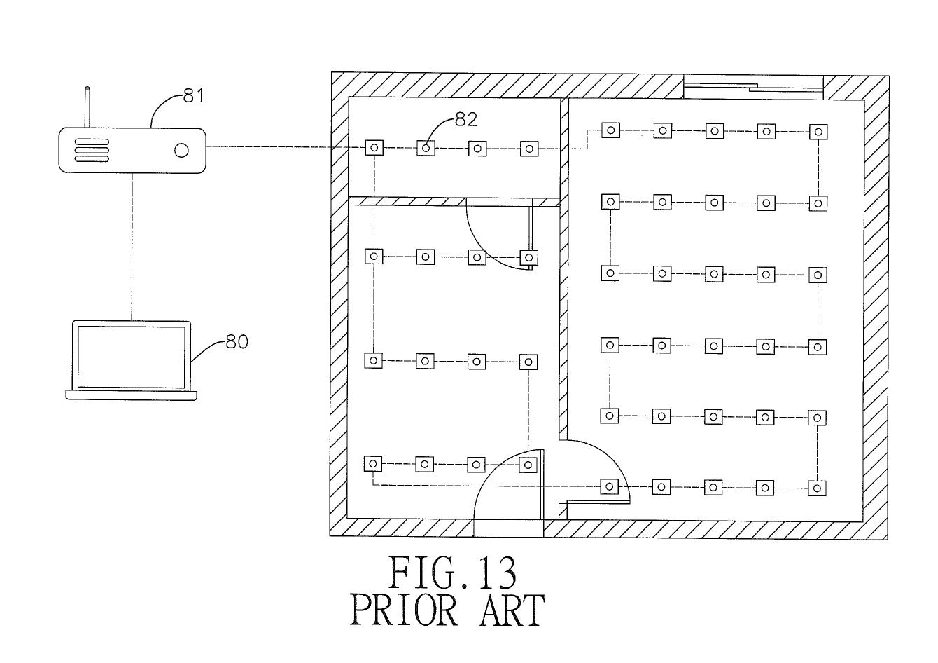

### DETAILED DESCRIPTION OF THE INVENTION

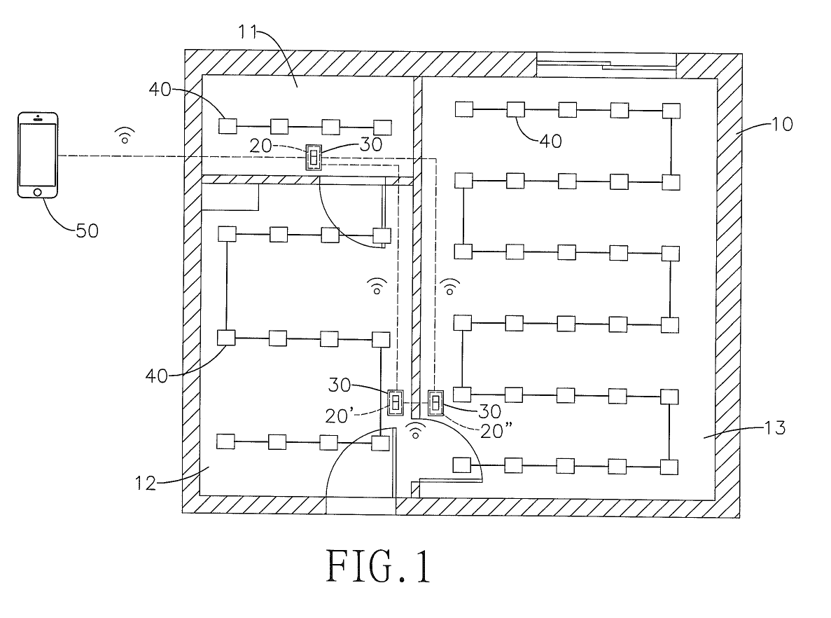

With reference to FIG. 1, a first embodiment of a power switch control system with area-based switch grouping in accordance with the present invention includes multiple intelligent switches 20 respectively mounted inside multiple switch wiring boxes 30. The multiple switch wiring boxes 30 are originally and selectively mounted in multiple compartments of a building 10. Each switch wiring box 30 has a power distribution circuit mounted inside the switch wiring box 30 and connected to multiple pieces of power-consuming equipment. To ease understanding, the multiple pieces of power-consuming equipment include but are not limited to multiple lamps 40, which are taken as an example.

In the present embodiment, the building 10 totally has three compartments 11-13, and one switch wiring box 30 is mounted in one of the three compartments 11-13 and each intelligent switch 20, 20′, 20″ is mounted inside a corresponding switch wiring box 30. It is noted that more than one switch wiring box 30 may be mounted in any compartment 11-13 of the building 10. In other words, each compartment 11-13 may have multiple switch wiring boxes 30 therein, and all or a part of the multiple switch wiring boxes 30 serve for corresponding number of intelligent switches 20, 20′, 20″ to be mounted therein.

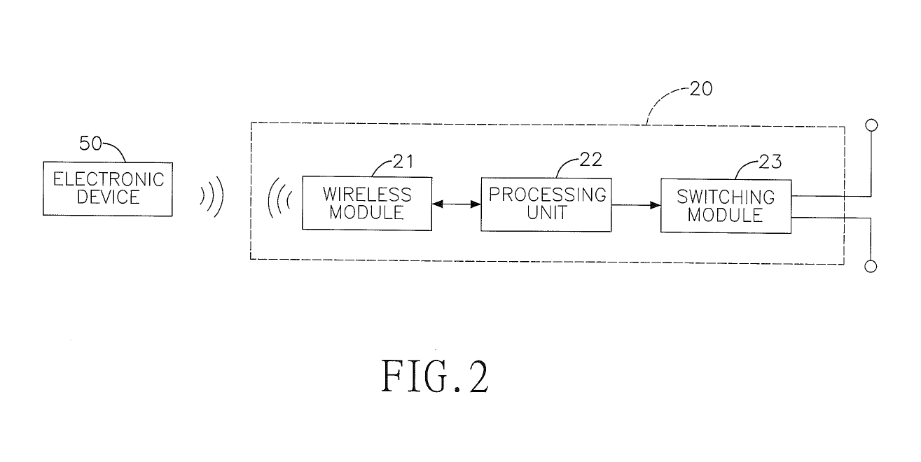

With reference to FIG. 2, a first embodiment of the intelligent switch 20 in FIG. 1 receives a switch control command from an electronic device 50 according to a wireless communication protocol. The electronic device 50 may be a mobile device or a personal computer. The mobile device includes but is not limited to a smart phone, a tablet personal computer (PC) or a wearable electronic device. In the present embodiment, the intelligent switch 20 includes a wireless module 21, a processing unit 22, and a switching module 23. The wireless module 21 is wirelessly connected to the electronic device 50 according to the wireless communication protocol IEEE 802.11 (WiFi). The processing unit 22 is bidirectionally connected to the wireless module 21 and receives the switch control command or transmits data through the wireless module 21. The switching module 23 is connected to the processing unit 22 and is turned on or off according to the switch control command received from the processing unit 22. When the intelligent switch 20 is mounted inside a corresponding switch wiring box 30, the switching module 23 is connected to original multiple wires of the switch wiring box 30. In other words, multiple pieces of power-consuming equipment originally controlled by switches mounted on the switch wiring box 30 are controlled by the intelligent switch 20. Thus, after the intelligent switch 20 is mounted in the corresponding switch wiring box 30, the multiple lamps in each compartment originally controlled by the switches of the switch wiring box 30 in the compartment are naturally formed as a group and are controlled by the intelligent switch 20.

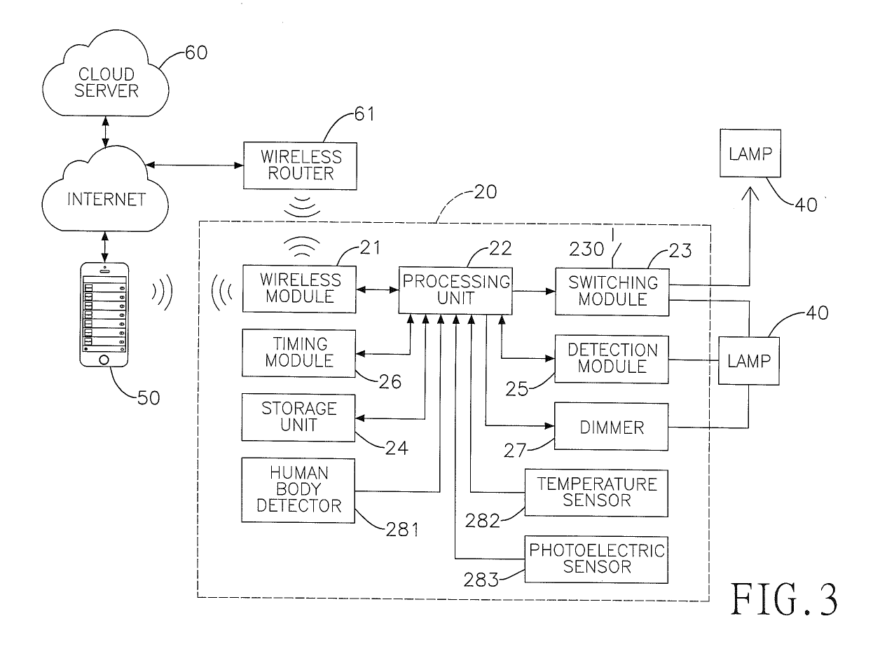

With reference to FIG. 3, in comparison with the foregoing embodiment, a second embodiment of the intelligent switch 20 in FIG. 1 further includes a storage unit 24, a detection module 25, a timing module 26, and at least one sensor. When applied to control multiple lamps 40, the intelligent switch 20 further has a dimmer 27, and the switching module 23 is further connected to a manual switch 230 for a user adjacent to the switch wiring box 30 to manually turn on or off the multiple lamps.

The detection module 25 is connected to the processing unit 22 to detect multiple sets of power usage information of the multiple lamps 40, including voltage, current, power, power factor and the like, and transmits the multiple sets of power usage information to the processing unit 22 for the processing unit 22 to store the power usage information in the storage unit 24. The processing unit 22 reads a corresponding set of power usage information according to a request issued from the electronic device 50, and transmits the corresponding set of power usage information to the electronic device 50 through the wireless module 21. The timing module 26 is connected to the processing unit 22. The processing unit 22 can automatically control the multiple lamps 40 according to the switch control command from the electronic device 50 to schedule a time to turn on or off the multiple lamps 40.

The dimmer 27 serves to adjust luminance of the multiple lamps 40 manually or according to a request from the electronic device 50. The at least one sensor is electrically connected to the processing unit 22, and includes, but is not limited to, a human body detector 281, a temperature sensor 282 and/or a photoelectric sensor 283. The human body detector 281 serves to detect the presence of people inside a compartment and automatically turn on or off the multiple lamps 40, and may be an infrared sensor or a far infrared sensor. For example, when the human body sensor 281 of the intelligent switch 20 detects no presence of people in a compartment, it indicates that all people in the compartment have left and the human body sensor 281 transmits a sensing signal to the processing unit 22 for the processing unit 22 to turn off the lamps 40 through the switching module 23.

The photoelectric sensor 283 serves to detect lighting luminance in a compartment. When the compartment has windows and the windows are open, natural light through the windows assists lighting in the compartment. After the natural light provides sufficient lighting luminance in the compartment and a total luminance in the compartment detected by the photoelectric sensor 283 reaches a preset value, the processing unit 22 is informed by the photoelectric sensor 283 to adjust the multiple lamps 40 to acquire an appropriate total luminance through the dimmer 27.

The temperature sensor 282 serves to detect a temperature of the ambient environment around the switch wiring box 30 and transmit a temperature sensing signal to the processing unit 22 for the processing unit 22 to turn on or off the lamps 40 through the switching module 23 or transmit a remote control command through the wireless module 21. Supposing that the intelligent switch 20 serves to control an air conditioner in a compartment, after detecting that an indoor temperature of the compartment is higher than a specific temperature, the intelligent switch 20 automatically turns on the air conditioner; otherwise, the intelligent switch 20 turns off the air conditioner or adjusts an air volume.

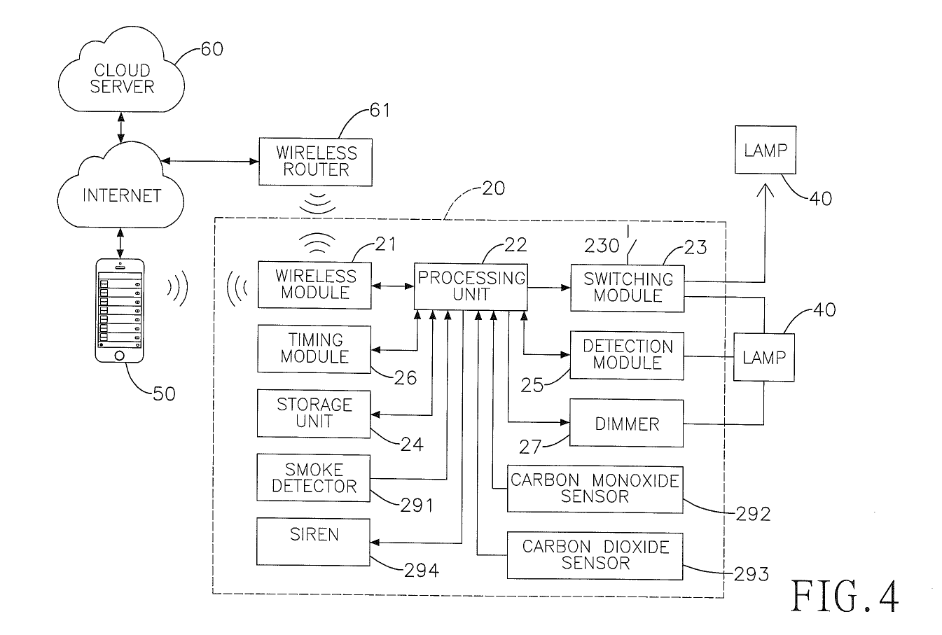

In addition to the foregoing sensors, the intelligent switch 20 may further include other sensors. With reference to FIG. 4, the intelligent switch 20 further includes a smoke detector 291, a carbon monoxide sensor 292 and/or a carbon dioxide sensor 293. The smoke detector 291, the carbon monoxide sensor 292, and the carbon dioxide sensor 293 are connected to the processing unit 22. By incorporating the smoke detector 291, the carbon monoxide sensor 292 and the carbon dioxide sensor 293 into the intelligent switch 20, the intelligent switch 20 can detect if the concentration of smoke, carbon monoxide, and carbon dioxide exceeds a threshold.

To immediately and actively process sensed results of the foregoing sensors, the processing unit 22 is further connected to a siren 294 to generate an alarm signal when the concentration of smoke, carbon monoxide or carbon dioxide exceeds the threshold, and the alarm signal can be simultaneously sent to the electronic device 50.

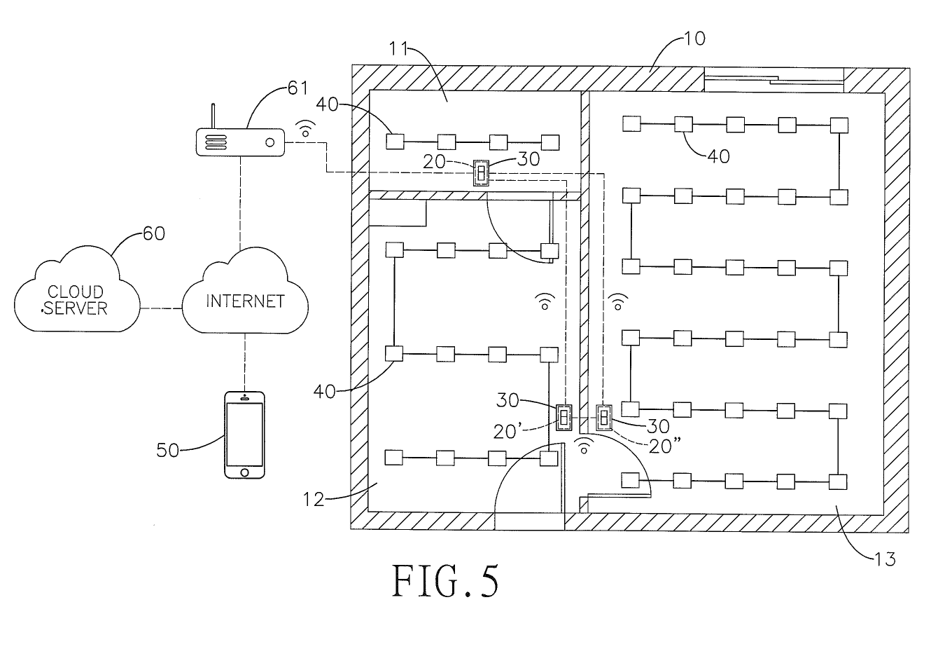

As mentioned earlier, the electronic device 50 can wirelessly and directly transmit the switch control command or a request command to the intelligent switch 20 for the intelligent switch 20 to directly transmit the multiple sets of power usage information and multiple pieces of sensing information to the electronic device. Besides, the intelligent switch 20 can transmit the multiple sets of power usage information and the multiple pieces of sensing information to a cloud server 60. To acquire the multiple sets of power usage information and the multiple pieces of sensing information, the electronic device 50 can either access each intelligent switch 20 or download information from each intelligent switch 20 from the cloud server 60. With reference to FIG. 5, a second embodiment of a power switch control system with area-based switch grouping in accordance with the present invention further has a wireless router 61 wirelessly connected to each intelligent switch 20 and the internet. Hence, the intelligent switch 20 can be connected to the internet and to the cloud server 60 and the electronic device 50 through the internet.

Under the forgoing system architectures, the electronic device 50 can directly access information from the intelligent switch 20 through WiFi or can be indirectly connected to the intelligent switch 20 through the internet. Each intelligent switch 20 can upload the power usage information of a group pertaining to the intelligent switch 20 the cloud server 60 through the internet. The electronic device 50 can download the power usage information of a corresponding group controlled by each intelligent switch 20 from the cloud server 60 through the internet. Additionally, the intelligent switch 20 inside a switch wiring box 30 located in each compartment of the building 10 can also function as a wireless repeater for the electronic device 50 to be connected to the internet through the intelligent switch 20.

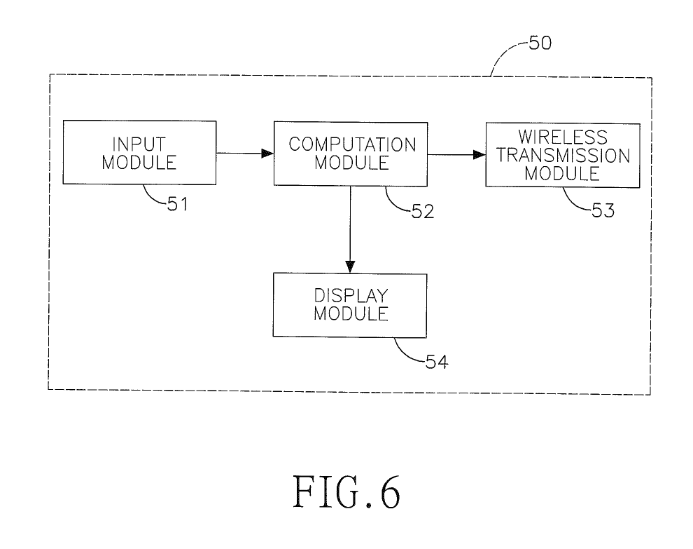

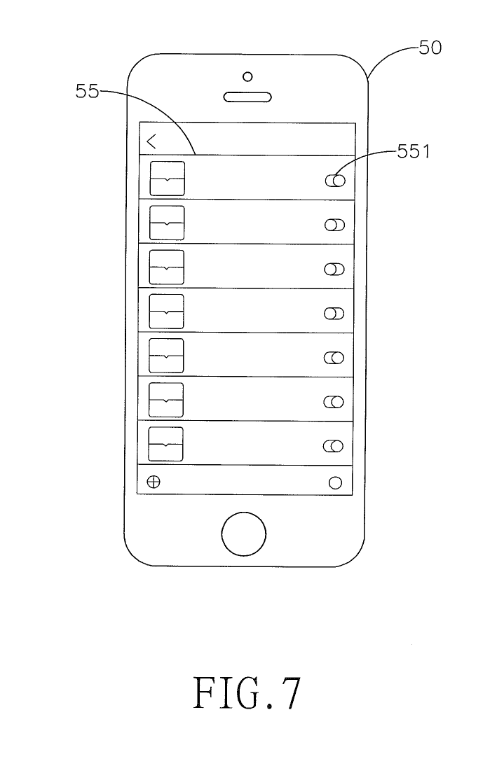

With reference to FIG. 6, the electronic device 50 includes an input module 51, a computation module 52, a wireless transmission module 53, and a display module 54. The computation module 52 is connected to the input module 51, the wireless transmission module 53, and the display module 54. When the electronic device becomes a mobile device with touch functionality, the input module 51 and the display module 54 are integrated into a touch panel. Moreover, the computation module 52 of the electronic device 50 is built in with an application performing switching control and information access provided by the intelligent switch 20. When the electronic device 50 is a smart phone or a tablet PC, the application is a mobile application (APP) that provides an operation interface. With reference to FIG. 7, the operation interface contains a switch control page 55 displaying a control item for each intelligent switch 20. Each control item has a switch button 551. When the switch button 551 is pushed to an ON state, the electronic switch 50 sends a control command to a corresponding intelligent switch 20 to activate the corresponding intelligent switch 20. When the switch button 551 is pushed to an OFF state, the electronic switch 50 then sends a control command to the corresponding intelligent switch 20 to deactivate the corresponding intelligent switch 20.

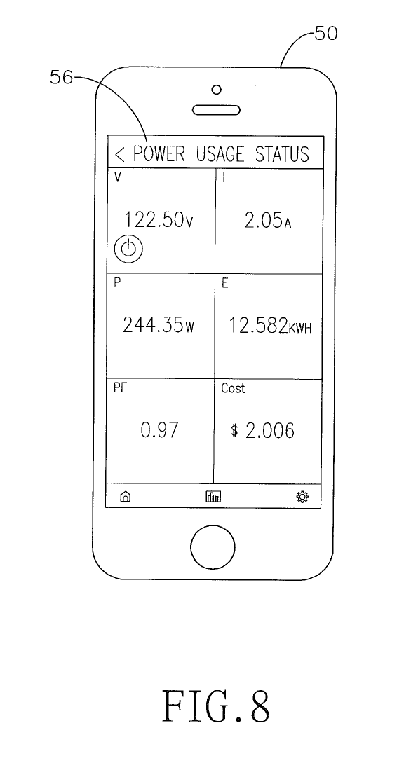

With reference to FIG. 8, when users click the control item of one of the intelligent switches 20, the operation interface further provides a power usage information display page 56 for the intelligent switch 20. The power usage information display page 56 displays a set of power usage information of a corresponding group controlled by the intelligent switch 20, including voltage (V), current (I), power (P), electricity consumption (E), power factor (PF), and billing charge for users to monitor and manage power utilization of the controlled group.

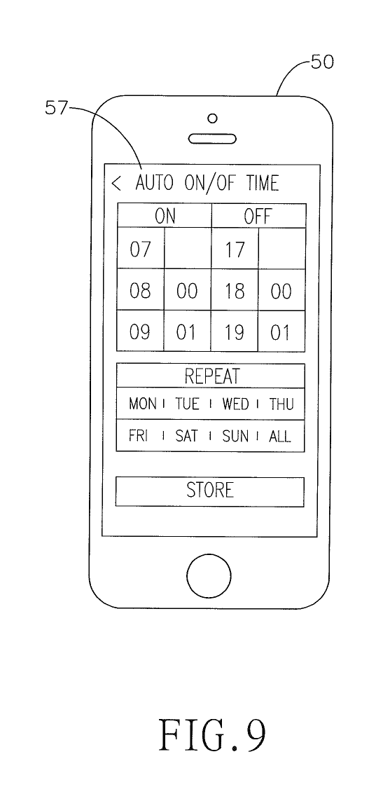

As each intelligent switch 20 further has the timing module 26, the operation interface of the electronic device 50 further provides a control schedule configuration page 57 to the intelligent switch 20 as shown in FIG. 9 for users to configure schedules for activating/deactivating the intelligent switch 20, specifically, the on/off time in each time unit (e.g. a day) of a period of time (e.g. a week), and to store the schedules after the configuration. The operation interface further sends the schedules to the storage unit 24 of the intelligent switch 20 for storage. The processing unit 22 of the intelligent switch 20 activates or deactivates the lamps 40 through the switching module 23 according to the schedules stored in the storage unit 24 and a current time read from the timing module 26.

As to operation of the power switch control system, the originally planned compartments inside the building 10 are taken as the areas where the multiple pieces of power-consuming equipment to be controlled by the original switch wiring boxes 30 are located to naturally form the groups to be controlled. Each intelligent switch 20 is mounted inside a corresponding switch wiring box 30 in a corresponding compartment and is connected to the power distribution circuit of the switch wiring box 30 originally connected to a corresponding piece of power-consuming equipment. Given the lamps in conference room and offices as an example, each switch wiring box 30 is responsible for control over activation and deactivation of multiple lamps 40 and such planning for lighting in the compartments of the building is done prior to the completion of the building. Therefore, the groups naturally formed by the respective switch wiring boxes 30 in the compartments serves as the most appropriate control mechanism.

With further reference to FIG. 1, the multiple lamps 40 and the multiple switch wiring boxes 30 are mounted in each compartment 11-13 of the building 10. The switch wiring boxes 30 in each compartment 11-13 are connected to corresponding lamps 40 in the compartment 11-13 to control activation and deactivation of the lamps 40. The lamps 40 located inside each compartment 11-13 and a corresponding switch wiring box 30 connected to the lamps 40 are considered as a group to be controlled. Each switch wiring box 30 has an intelligent switch 20, 20′, 20″ mounted inside the switch wiring box 30 and connected to the corresponding lamps 40. Thus, one electronic device 50 can be used to sequentially or simultaneously transmit the switch control command to the intelligent switches 20, 20′, 20″ in the compartments 11-13 and sequentially or simultaneously turn on or off the lamps 40 in the compartments 11-13.

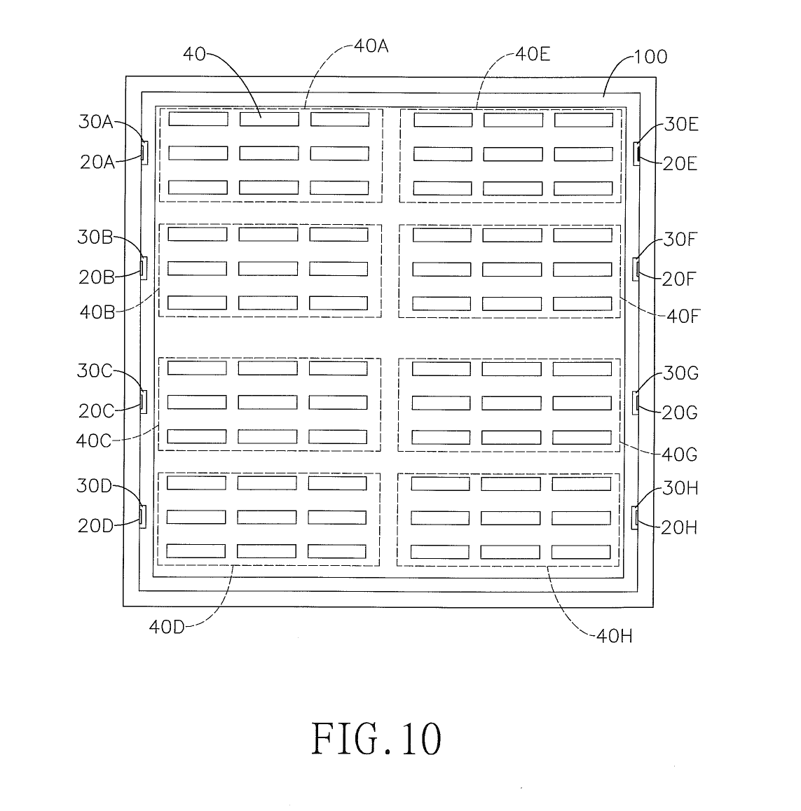

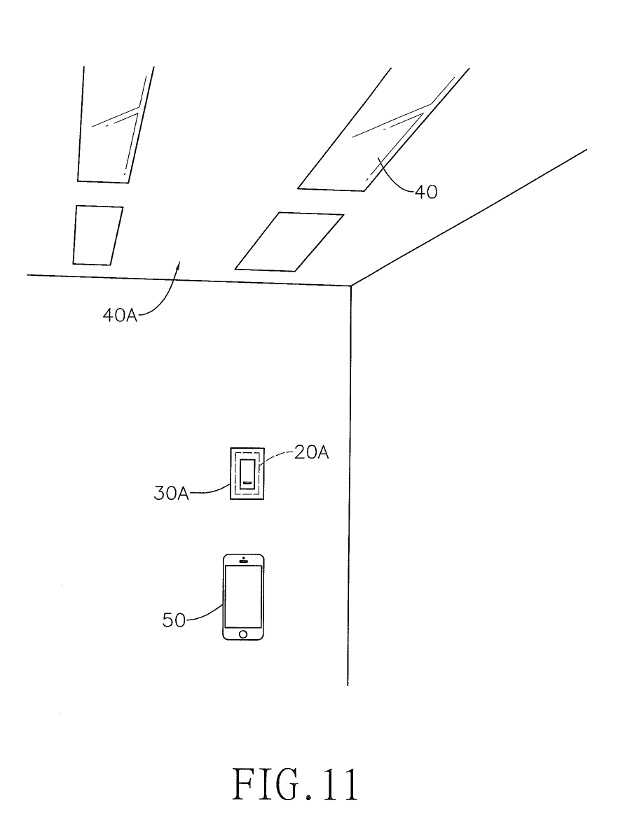

With reference to FIGS. 10 and 11, a conference room 100 with multiple lamps 40 and multiple switch wiring boxes 30A-30H is shown. Each switch wiring box 30A-30H is connected to multiple lamps 40 adjacent to the switch wiring box 30A-30H to control activation and deactivation of the multiple lamps 40. One intelligent switch 20A-20H is mounted inside a corresponding switch wiring box 30A-30H and is connected to the lamps 40 of a corresponding group to be controlled. Thus, one electronic device 50 can be used to sequentially or simultaneously transmit the switch control command to the intelligent switches 20A-20H and sequentially or simultaneously turn on or off the lamps 40A-40H of a group to be controlled

The advantages of using the power switch control system at least include the following:

1. Easy construction: As the power switch control system utilizes the original switch wiring boxes in the compartments of a building and each intelligent switch is connected to power-consuming equipment through original circuit inside a corresponding switch wiring box, there is no need for rewiring as far as the control over the power-consuming equipment is concerned.

2. Significant cost reduction: Due to cost saving in rewiring and no transceiving device required in power-consuming equipment to be controlled, the original power-consuming equipment can be still used without any change, thereby greatly lowering operational cost. A budgetary analysis among the power switch control system of the present invention, the DALI system, and the IOT system shown in the following table can readily tell the difference in cost (an example for lighting demand in a commercial building with a floor area 100,000 square feet).

| | | | Present |
|---|---|---|---|
| | DALI | IOT | invention |
| Lamps | $100 × | $150 × | X |
| (5,000 lamps) | 5000 = $500k | 5000 = $750k | |
| Controller | $369 × | X | X |
| (64 Channels) | 79 = $30k | | |
| Intelligent switch | X | X | $150 × |
| | | | 1000 = $150k |
| Lamp construction | $100 × | $100 × | $100 × |
| (0.5 hour/lamp) | 2500 = $250k | 2500 = $250k | 500 = $50k |
| Controller construction | $100 × | X | X |
| (8 hours/controller) | 79 × 8 = $63k | | |
| Total (U.S. Dollar) | $843k | $1,000k | $200k |

3. Expandable sensing functions: Besides detecting the power usage information of each group and feeding back the detected power usage information to an electronic device and/or a cloud server, the intelligent switch can be further integrated with various types of sensors to control activation or deactivation of power-consuming equipment according to detected results of the integrated sensors. For example, a photoelectric sensor is integrated with a dimmer to adjust a desired luminance of a lighting area, a temperature sensor is used for adjustment of air-conditioning temperature or air volume, a human body detector is used to detect the presence of any person around for automatically performing activation or deactivation of power-consuming equipment, a smoke detector, a carbon monoxide sensor, and a carbon dioxide sensor serve for fire protection and monitoring of indoor air quality, and a timing module is used to schedule activation or deactivation of power-consuming equipment for enhancing power utilization efficiency.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A power switch control system with area-based switch grouping, comprising:
multiple intelligent switches respectively located in at least one compartment of a building, respectively mounted inside multiple switch wiring boxes originally and selectively located in the at least one compartment, and respectively connected to multiple power distribution circuits inside the respective switch wiring boxes, each intelligent switch receiving a switch control command according to a wireless communication protocol; and
an electronic device generating the switch control command and transmitting the switch control command to each intelligent switch according to the wireless communication protocol.

2. The power switch control system as claimed in claim 1, wherein each intelligent switch further includes:
a wireless module wirelessly connected to the electronic device according to the wireless communication protocol;
a processing unit bidirectionally connected to the wireless module; and
a switching module connected to the power distribution circuit inside a corresponding switch wiring box and controlled by the processing unit.

3. The power switch control system as claimed in claim 2, wherein each intelligent switch further includes:
a detection module connected to the processing unit for detecting a set of power usage information of multiple pieces of power-consuming equipment pertaining to a group controlled by the intelligent switch;
a storage unit connected to the processing unit for storing the set of power usage information; and
a timing module connected to the processing unit.

4. The power switch control system as claimed in claim 3, wherein the switching module is connected to a manual switch.

5. The power switch control system as claimed in claim 3, wherein the intelligent switch further includes:
a dimmer connected to the processing unit; and
a photoelectric sensor connected to the processing unit.

6. The power switch control system as claimed in claim 3, wherein the intelligent switch further includes a human body detector connected to the processing unit.

7. The power switch control system as claimed in claim 3, wherein the intelligent switch further includes a temperature sensor connected to the processing unit.

8. The power switch control system as claimed in claim 3, wherein the intelligent switch further includes a smoke detector connected to the processing unit.

9. The power switch control system as claimed in claim 3, wherein the intelligent switch further includes a carbon monoxide sensor connected to the processing unit.

10. The power switch control system as claimed in claim 3, wherein the intelligent switch further includes a carbon dioxide sensor connected to the processing unit.

11. The power switch control system as claimed in claim 8, wherein the processing unit is connected to a siren.

12. The power switch control system as claimed in claim 9, wherein the processing unit is connected to a siren.

13. The power switch control system as claimed in claim 10, wherein the processing unit is connected to a siren.

14. The power switch control system as claimed in claim 1, further comprising:
a wireless router wirelessly connected to the multiple intelligent switches for each intelligent switch to connect to an internet; and
a cloud server selectively connected to the wireless router and the electronic device through the internet.

15. The power switch control system as claimed in claim 2, further comprising:
a wireless router wirelessly connected to the multiple intelligent switches for each intelligent switch to connect to an internet; and
a cloud server selectively connected to the wireless router and the electronic device through the internet.

16. The power switch control system as claimed in claim 3, further comprising:
a wireless router wirelessly connected to the multiple intelligent switches for each intelligent switch to connect to an internet; and
a cloud server selectively connected to the wireless router and the electronic device through the internet.

17. The power switch control system as claimed in claim 4, further comprising:
a wireless router wirelessly connected to the multiple intelligent switches for each intelligent switch to connect to an internet; and
a cloud server selectively connected to the wireless router and the electronic device through the internet.

18. The power switch control system as claimed in claim 5, further comprising:
a wireless router wirelessly connected to the multiple intelligent switches for each intelligent switch to connect to an internet; and
a cloud server selectively connected to the wireless router and the electronic device through the internet.

19. The power switch control system as claimed in claim 6, further comprising:
a wireless router wirelessly connected to the multiple intelligent switches for each intelligent switch to connect to an internet; and
a cloud server selectively connected to the wireless router and the electronic device through the internet.

20. The power switch control system as claimed in claim 7, further comprising:
a wireless router wirelessly connected to the multiple intelligent switches for each intelligent switch to connect to an internet; and
a cloud server selectively connected to the wireless router and the electronic device through the internet.

21. The power switch control system as claimed in claim 8, further comprising:
a wireless router wirelessly connected to the multiple intelligent switches for each intelligent switch to connect to an internet; and
a cloud server selectively connected to the wireless router and the electronic device through the internet.

22. The power switch control system as claimed in claim 9, further comprising:
a wireless router wirelessly connected to the multiple intelligent switches for each intelligent switch to connect to an internet; and
a cloud server selectively connected to the wireless router and the electronic device through the internet.

23. The power switch control system as claimed in claim 10, further comprising:
a wireless router wirelessly connected to the multiple intelligent switches for each intelligent switch to connect to an internet; and
a cloud server selectively connected to the wireless router and the electronic device through the internet.

24. The power switch control system as claimed in claim 14, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

25. The power switch control system as claimed in claim 15, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

26. The power switch control system as claimed in claim 16, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

27. The power switch control system as claimed in claim 17, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

28. The power switch control system as claimed in claim 18, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

29. The power switch control system as claimed in claim 19, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

30. The power switch control system as claimed in claim 20, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

31. The power switch control system as claimed in claim 21, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

32. The power switch control system as claimed in claim 22, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

33. The power switch control system as claimed in claim 23, wherein the electronic device is built in with an application providing an operation interface, wherein the operation interface includes:
a switch control page displaying a control item for each intelligent switch, wherein each control item has a switch button;
a power usage information display page displaying a set of power usage information of the multiple pieces of power-consuming equipment of a corresponding group controlled by the intelligent switch; and
a control schedule configuration page provided to configure schedules for activating and deactivating each intelligent switch.

34. The power switch control system as claimed in claim 24, wherein the electronic device further includes an input module, a computation module, a wireless transmission module, and a display module, wherein the input module and the wireless transmission module are connected to the computation module.

35. The power switch control system as claimed in claim 25, wherein the electronic device further includes an input module, a computation module, a wireless transmission module, and a display module, wherein the input module and the wireless transmission module are connected to the computation module.

36. The power switch control system as claimed in claim 26, wherein the electronic device further includes an input module, a computation module, a wireless transmission module, and a display module, wherein the input module and the wireless transmission module are connected to the computation module.

37. The power switch control system as claimed in claim 27, wherein the electronic device further includes an input module, a computation module, a wireless transmission module, and a display module, wherein the input module and the wireless transmission module are connected to the computation module.

38. The power switch control system as claimed in claim 28, wherein the electronic device further includes an input module, a computation module, a wireless transmission module, and a display module, wherein the input module and the wireless transmission module are connected to the computation module.

39. The power switch control system as claimed in claim 29, wherein the electronic device further includes an input module, a computation module, a wireless transmission module, and a display module, wherein the input module and the wireless transmission module are connected to the computation module.

40. The power switch control system as claimed in claim 30, wherein the electronic device further includes an input module, a computation module, a wireless transmission module, and a display module, wherein the input module and the wireless transmission module are connected to the computation module.

41. The power switch control system as claimed in claim 31, wherein the electronic device further includes an input module, a computation module, a wireless transmission module, and a display module, wherein the input module and the wireless transmission module are connected to the computation module.

42. The power switch control system as claimed in claim 32, wherein the electronic device further includes an input module, a computation module, a wireless transmission module, and a display module, wherein the input module and the wireless transmission module are connected to the computation module.

43. The power switch control system as claimed in claim 33, wherein the electronic device further includes an input module, a computation module, a wireless transmission module, and a display module, wherein the input module and the wireless transmission module are connected to the computation module.
